(19) United States
(12) Patent Application Publication
(10) Pub. No.: US 2026/0244250 A1
(43) Pub. Date: Aug. 20, 2026

(54) STORAGE DEVICE CARRIER WITH ROBUST DEVICE ATTACHMENT

(71) Applicant: Western Digital Technologies, Inc., San Jose, CA (US)

(72) Inventor: Michael Koch, Colorado Springs, CO (US)

(21) Appl. No.: 19/056,564

(22) Filed: Feb. 18, 2025

(51) Int. Cl. G06F 1/18; G11B 33/12

(52) U.S. Cl. CPC G06F 1/187; G11B 33/124

(57) ABSTRACT

A device carrier assembly, such as for a storage device, includes a flexure component and a stiffener component removably coupled together. The flexure includes a laterally-extending end member having a flexure region, a rigid device interface member longitudinally-extending from each end of the end member, and stiffener attachment features extending from the end member in a direction opposing the device interface members. The stiffener includes attachment features configured to mechanically interface with corresponding attachment features of the flexure to removably secure the parts together. Each device interface member of the flexure includes a mounting pin for insertion into a corresponding receptacle of a device to which the flexure is attachable, and the flexure region of the flexure is configured to bend to allow displacement of the device interface members for insertion of the mounting pins into the corresponding device receptacles to removably secure the carrier assembly to the device.

### FIELD OF EMBODIMENTS

Embodiments of the invention may relate generally to the handling of data storage devices and particularly to a storage device carrier with improved device attachment.

### BACKGROUND

As networked computer systems grow in numbers and capability, there is a need for more storage system capacity. Cloud computing and large-scale data processing further increase the need for digital data storage systems that are capable of transferring and holding significant amounts of data. One approach to providing sufficient data storage is the use of arrays of data storage devices (DSDs) in data centers. Many DSDs can be housed in an electronics enclosure (sometimes referred to as a “rack”), which is typically a modular unit that can hold and operate independent DSDs in an array, computer processors, routers, and other electronic equipment. As data centers typically include many rack-mountable storage devices that are used to store the large amounts of data, a non-trivial amount of device handling such as for installing/removing devices may be necessary in the course of provisioning and maintaining a data storage system.

Any approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a perspective view illustrating a device carrier mechanism attached to a storage device, according to an embodiment;

FIG. 2 is a perspective view illustrating the device carrier mechanism (assembly) of FIG. 1, according to an embodiment;

FIG. 3A is a top view illustrating a flexure component of the device carrier assembly of FIG. 2, according to an embodiment;

FIG. 3B is a front view illustrating the flexure component of the device carrier assembly of FIG. 2, according to an embodiment;

FIG. 3C is a side view illustrating the flexure component of the device carrier assembly of FIG. 2, according to an embodiment;

FIG. 4A is a top view illustrating a stiffener component of the device carrier assembly of FIG. 2, according to an embodiment;

FIG. 4B is a front view illustrating the stiffener component of the device carrier assembly of FIG. 2, according to an embodiment;

FIG. 4C is a side view illustrating the stiffener component of the device carrier assembly of FIG. 2, according to an embodiment;

FIG. 5 is a plan view illustrating attachment of the flexure component of the device carrier assembly of FIG. 2, according to an embodiment;

FIG. 6A is a plan view illustrating attachment of the stiffener component of the device carrier assembly of FIG. 2, according to an embodiment;

FIG. 6B is a plan view illustrating attachment of the stiffener component of the device carrier assembly of FIG. 2, according to an embodiment; and

FIG. 7 is a flow diagram illustrating a method of attaching a device carrier to a device, according to an embodiment.

### DETAILED DESCRIPTION

Generally, approaches to a storage device carrier such as for hard disk drives (HDDs) are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices may be shown in block diagram form in order to avoid unnecessarily obscuring the embodiments of the invention described herein.

### Introduction

### Terminology

References herein to “an embodiment”, “one embodiment”, and the like are intended to mean that the particular feature, structure, or characteristic being described is included in at least one embodiment of the invention. However, instances of such phrases do not necessarily all refer to the same embodiment.

The term “substantially” will be understood to describe a feature that is largely or nearly structured, configured, dimensioned, etc., but with which manufacturing tolerances and the like may in practice result in a situation in which the structure, configuration, dimension, etc. is not always or necessarily precisely as stated. For example, describing a structure as “substantially vertical” would assign that term its plain meaning, such that the structure is vertical for all practical purposes but may not be precisely at 90 degrees throughout.

While terms such as “optimal”, “optimize”, “minimal”, “minimize”, “maximal”, “maximize”, and the like may not have certain values associated therewith, if such terms are used herein, the intent is that one of ordinary skill in the art would understand such terms to include affecting a value, parameter, metric, and the like in a beneficial direction consistent with the totality of this disclosure. For example, describing a value of something as “minimal” does not require that the value actually be equal to some theoretical minimum (e.g., zero), but should be understood in a practical sense in that a corresponding goal would be to move the value in a beneficial direction toward a theoretical minimum.

### Context

Recall that data centers, and even stand-alone data systems, typically include multiple rack-mountable storage devices and that a non-trivial amount of device handling may be necessary to provision and maintain such systems. Thus, device carrier mechanisms are typically employed to physically handle attached storage devices, such as during installation and removal of such devices from a system. Known approaches for attaching a device carrier to the device itself use attachment hardware (e.g., screws) or local (e.g., pin-adjacent) molded spring, snap-in pin features to mate with a corresponding receiving feature of the device (e.g., a threaded receptacle or mounting hole, respectively). However, device attachment with hardware is labor intensive and requires additional hardware parts (e.g., the screws). Snap-on carriers typically have the aforementioned local flexible regions (i.e., spring features) that require deflection to allow pin retention features to engage device mounting holes, and such deflecting features are often not robust enough for the intended usage and life cycle. Such a carrier can be difficult to install and remove, and removal can result in damage to the carrier. Thus, there is a need for a device carrier configured for ease of attachment to and removal from a corresponding device.

### Storage Device Carrier Mechanism

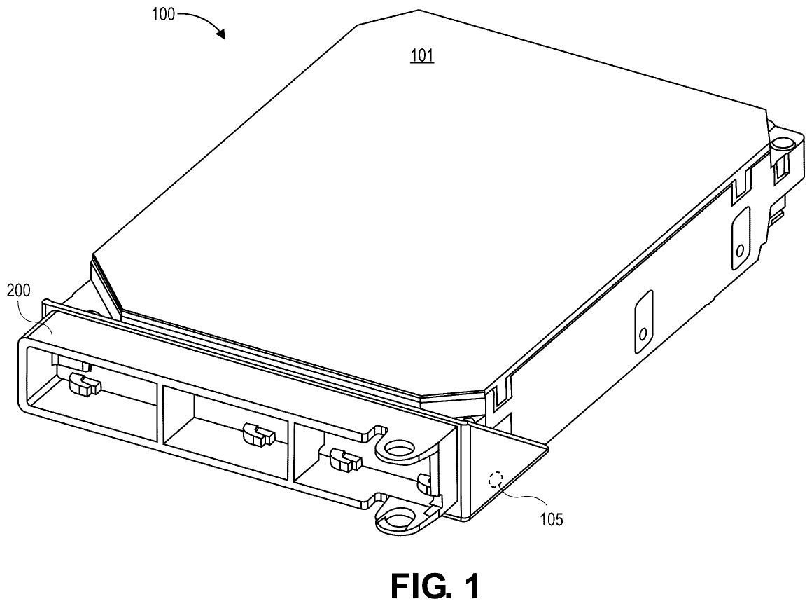

FIG. 1 is perspective view illustrating a device carrier mechanism attached to a storage device, according to an embodiment. Storage device assembly 100 comprises a storage device 101, such as a hard disk drive (HDD) or solid-state drive (SSD), to which a storage device carrier assembly 200 (“carrier assembly 200”) is removably coupled.

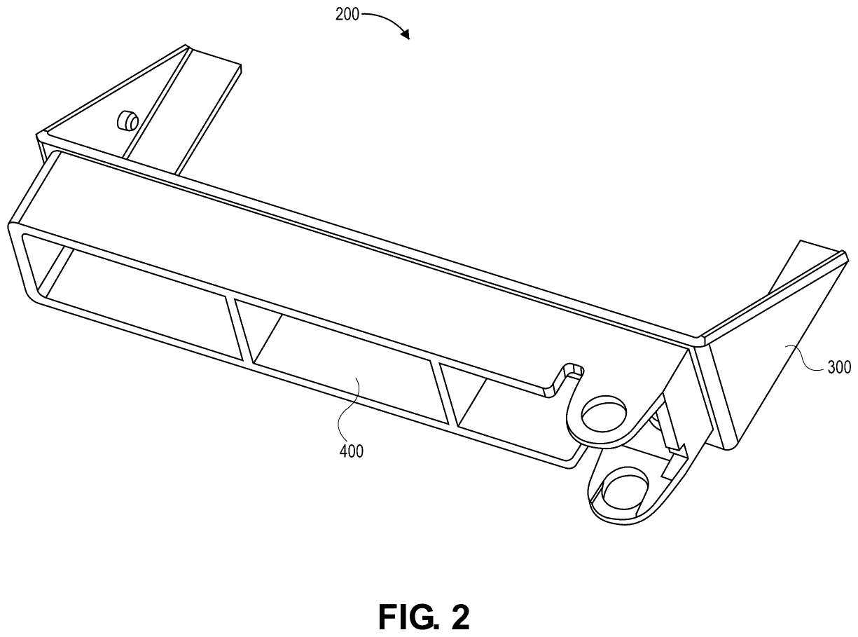

FIG. 2 is perspective view illustrating the device carrier mechanism (assembly) of FIG. 1, according to an embodiment. Carrier assembly 200 comprises a flexure component 300 (“flexure 300”) and a stiffener component 400 (“stiffener 400”) coupled with the flexure 300. As illustrated and described in reference to FIG. 1, as a storage device carrier, carrier assembly 200 is configured for removably coupling with (e.g., attaching to) a storage device 101. While the flexure 300 is configured to facilitate bending (“flexing”), slipping over, and removably attaching to the storage device 101, the stiffener 400 is configured to stiffen the installed flexure 300 to inhibit disengagement (e.g., undesired deflection) of flexure 300 from the storage device 101 and thereby temporarily “locking” the carrier assembly 200 in place. According to an embodiment, each of the flexure 300 and the stiffener 400 is composed of a plastic material (e.g., injection-molded plastic), with suitable flexibility and elasticity for the described intended purpose(s). According to embodiments, a carrier assembly 200 may be coupled with a corresponding storage device 101 during a device manufacturing process (and thus shipped as a storage device assembly 100 of FIG. 1, for example), by a purchaser or end user, or by any other entity handling the storage device 101.

### Storage Device Carrier Mechanism—Component Parts

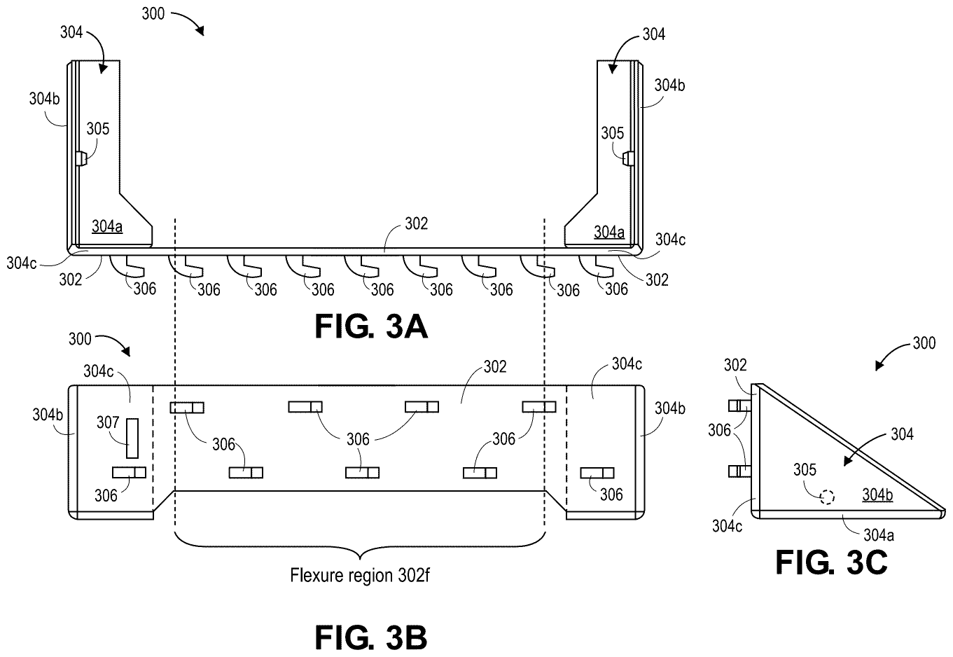

FIG. 3A is a top view illustrating a flexure component of the device carrier assembly of FIG. 2, FIG. 3B is a front view illustrating the flexure component of the device carrier assembly of FIG. 2, and FIG. 3C is a side view illustrating the flexure component of the device carrier assembly of FIG. 2, all according to one or more embodiments. Flexure 300 comprises a laterally-extending end member 302 comprising a flexure region 302f, a rigid device interface member 304 longitudinally-extending from each end of the end member 302, and stiffener attachment features 306 extending from the end member 302 in a direction opposing the device interface members 304. Note that the number of attachment features 306 may vary from implementation to implementation, with nine attachment features 306 considered suitable for the intended purpose and configured as depicted here for purposes of example. According to an embodiment, one or more of the stiffener attachment features 306 are configured as hooks. According to an embodiment, end member 302 further comprises a locking feature 307 (e.g., a locking receptacle) configured for engagement with a corresponding locking feature 407 of the stiffener 400.

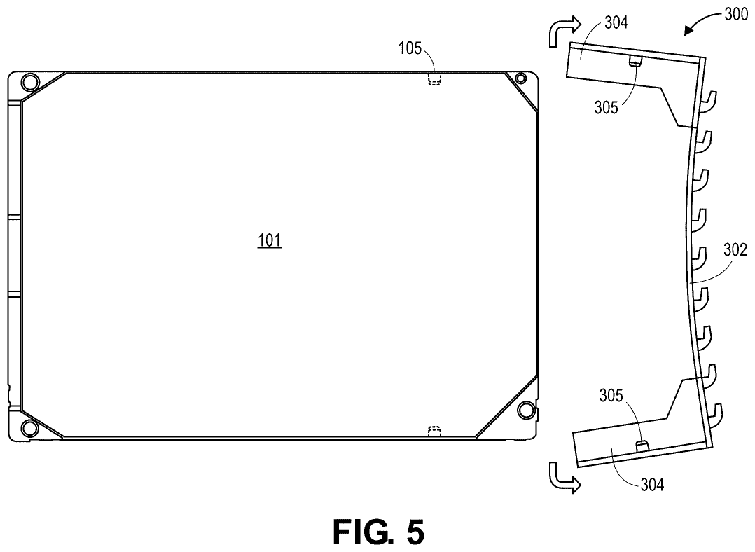

According to an embodiment, each device interface member 304 of the flexure 300 comprises a device-engagement pin 305 (may also be referred to as “mounting pin 305”) configured for insertion into a corresponding device receptacle 105 (FIG. 1) of a storage device 101 (FIG. 1) to which the flexure 300 is attachable (or attached). The flexure region 302f of the end member 302 of the flexure 300 is structurally configured to bend (to “flex”) to allow outward lateral displacement of the device interface members 304 (see, e.g., FIG. 5) for insertion of the mounting pins 305 into the corresponding device receptacles 105 of storage device 101.

The device interface members 304 of the flexure 300 are considered relatively structurally rigid based on their structural configuration. That is, each device interface member 304 comprises a floor 304a, a sidewall 304b, and an end wall 304c coupled with the floor 304a and the sidewall 304b, where a portion of the end member 302 functions as the end wall 304c of the device interface member 304. This combination of sub-structures connected together provides rigidity to each device interface member 304. As illustrated, and according to an embodiment, the sidewall 304b of at least one device interface member 304 is triangular in form, providing inherent structural strength in the plane of sidewall 304b.

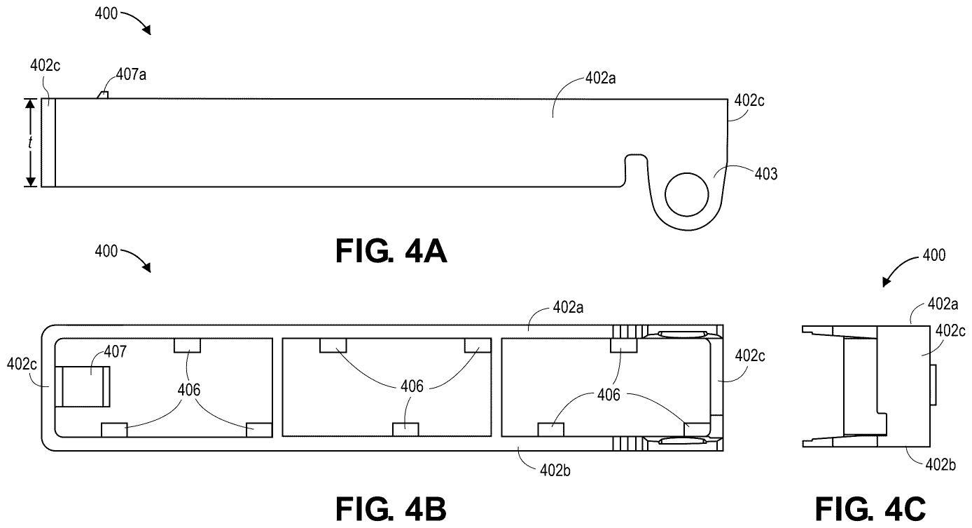

FIG. 4A is a top view illustrating a stiffener component of the device carrier assembly of FIG. 2, FIG. 4B is a front view illustrating the stiffener component of the device carrier assembly of FIG. 2, and FIG. 4C is a side view illustrating the stiffener component of the device carrier assembly of FIG. 2, all according to one or more embodiments. The aforementioned stiffener 400 is configured for coupling with the flexure 300, whereby the section thickness (t) of the stiffener 400 in the longitudinal direction provides rigidity to the flexure 300 while attached thereto. As such, according to an embodiment, the stiffener 400 comprises a top member 402a, a bottom member 402b, and at least one end member 402c all longitudinally-extending for a span greater than a corresponding thickness of the top, bottom, and end members 402a-402c, respectively.

According to an embodiment, stiffener 400 further comprises flexure attachment features 406 configured to mechanically interface with corresponding stiffener attachment features 306 (FIGS. 3A-3C) of the flexure 300. According to an embodiment, one or more of the flexure attachment features 406 are configured as tabs and positioned for engagement with corresponding hooks (as stiffener attachment features 306) of the flexure 300. According to an embodiment, stiffener 400 further comprises a locking feature 407 (e.g., a locking tab feature) configured for engagement with a corresponding locking feature 307 (e.g., a locking receptacle) of the flexure 300 via a protrusion 407a of locking feature 407. For a non-limiting example, and as depicted, locking feature 407 may be configured as an L-shaped feature from which an end nub (i.e., the protrusion 407a) protrudes from the longitudinal leg. Furthermore, and according to an embodiment, the stiffener 400 may comprise additional features related to the functionality of a storage device carrier, such as boss and bore 403 features for coupling with a corresponding mechanism (not shown) for handling of the storage device assembly 100 (FIG. 1). For example, an interfacing mechanism may be attached to the boss and bore 403 feature and utilized to cam the attached storage device into and out of an array and to retain the device in an array. Such mechanisms typically are designed to provide a mechanical advantage for mating and de-mating the device electrical connector(s) to and from the larger data storage system.

### Storage Device Carrier Mechanism—Attachment Procedure

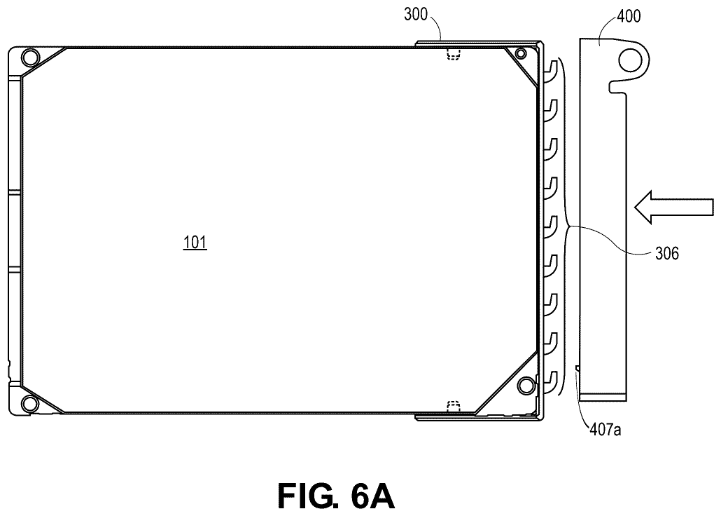

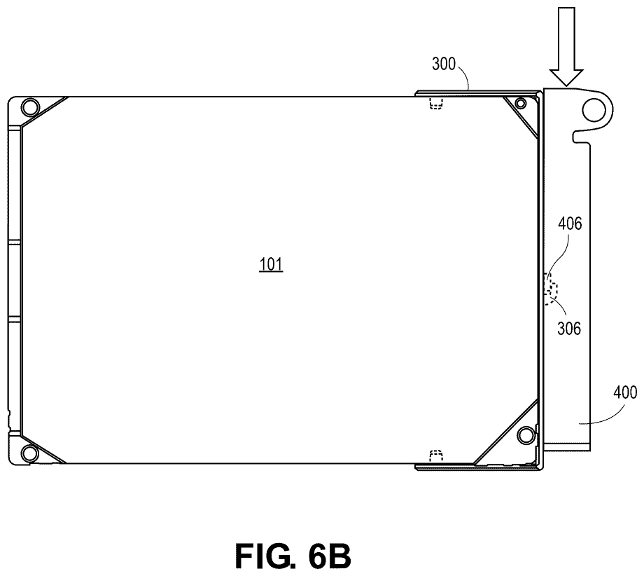

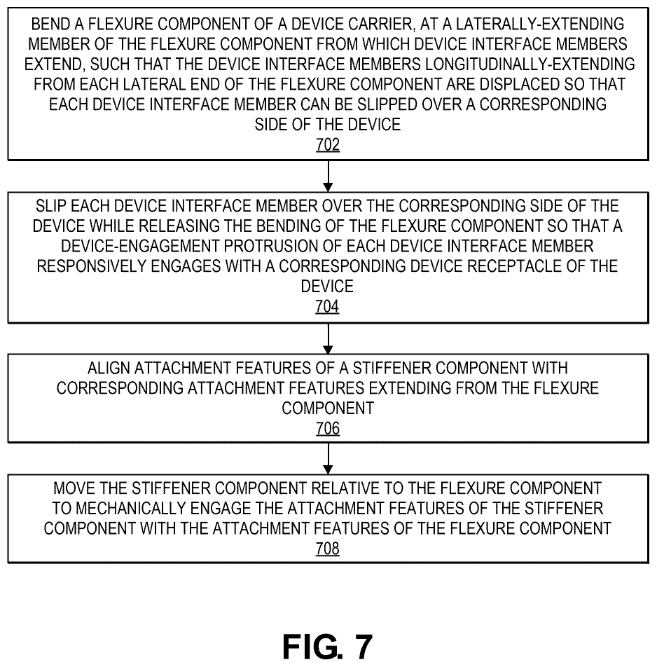

FIG. 7 is a flow diagram illustrating a method of attaching a device carrier to a device, according to an embodiment. FIG. 5 is a plan view illustrating attachment of the flexure component of the device carrier assembly of FIG. 2, according to an embodiment. FIG. 6A is a plan view illustrating attachment of the stiffener component of the device carrier assembly of FIG. 2, and FIG. 6B is another plan view illustrating attachment of the stiffener component of the device carrier assembly of FIG. 2, both according to embodiments. FIGS. 5-6B are presented in conjunction with the flow diagram of FIG. 7 to graphically illustrate actions corresponding to steps/blocks of the method of FIG. 7.

With reference to FIG. 7, at block 702, bend a flexure component of a device carrier such that device interface members longitudinally-extending from each lateral end of the flexure component are displaced so that each device interface member can be slipped over a corresponding side of the device. For example, and with reference to FIG. 5, flexure 300 (see also FIGS. 2-3C) of device carrier 200 (FIGS. 1-2) is bent such that device interface members 304 (see also FIGS. 3A-3C) longitudinally-extending from each lateral end of the flexure 300 are displaced (represented generally by block arrows) so that each device interface member 304 can be slipped over a corresponding side of a storage device 101 (see also FIG. 1). According to an embodiment, the bending (block 702) occurs at a laterally-extending member 302 (see also FIGS. 3A-3C) of the flexure 300, i.e., flexure region 302f (FIG. 3B), from which the device interface members 304 longitudinally extend.

At block 704, slip each device interface member over the corresponding side of the device while releasing the bending of the flexure component so that a device-engagement protrusion of each device interface member responsively engages with a corresponding device receptacle of the device. For example, each device interface member 304 is slipped over the corresponding side of the device 101 while releasing the bending of the flexure 300 so that a device-engagement protrusion 305 (see also FIGS. 3A, 3C) of each device interface member 304 responsively engages with a corresponding device receptacle 105 (see also FIG. 1) of the device 101. Block 704 may also be characterized as releasing the bending of the flexure while slipping each device interface member over the corresponding side of the device, as both releasing/slipping are to occur largely simultaneously.

At block 706, align attachment features of a stiffener component with corresponding attachment features extending from the flexure component. For example, and with reference to FIG. 6A, attachment features 406 (FIG. 4B; e.g., tabs) of stiffener 400 are aligned (generally represented by block arrow) with corresponding attachment features 306 (see also FIGS. 3A, 3C; e.g., hooks) extending from the flexure 300.

At block 708, move the stiffener component relative to the flexure component to mechanically engage the attachment features of the stiffener component with the attachment features of the flexure component. For example, and with reference to FIG. 6B, stiffener 400 is slid relative to the flexure 300 (generally represented by block arrow) to mechanically engage the attachment features 406 (e.g., tabs) of the stiffener 400 with the attachment features 306 (e.g., hooks) of the flexure 300. Attaching stiffener 400 to flexure 300 prevents/inhibits flexure 300 from deflecting and thus maintains device-engagement protrusion 305 engagement once installed. Note that FIG. 6B illustrates only one attachment hook 306/attachment tab 406 attachment to maintain illustrative clarity, however, flexure 300 and stiffener 400 are configured such that multiple attachment hook 306/attachment tab 406 engagements are enabled. According to an embodiment, locking feature 407 (FIG. 4B) of stiffener 400 ultimately engages with corresponding locking feature 307 (FIG. 3B) of the flexure 300 via a protrusion 407a (FIGS. 4A, 6A) of locking feature 407 to removably secure stiffener 400 to flexure 300. For example, while sliding stiffener 400 relative to flexure 300, locking feature 407 ultimately engages with locking feature 307 via the protrusion 407a (nub) of locking feature 407 in response to such features becoming aligned.

In view of the foregoing, described herein are approaches to a “snap-on” storage device (and/or other electronic devices) carrier configured for ease of attachment and removal from a corresponding device (e.g., requiring no additional hardware parts), whereby the device interface features (e.g., device interface member 304 of flexure 300 of FIGS. 3A, 3C) can be more robust (e.g., compared to other injection-molded plastic storage device carriers) because the flexible spring features (e.g., flexure region 302f of relatively long, lateral-spanned end member 302 of flexure 300 of FIG. 3B) are not in proximity to the attachment pin features (e.g., mounting pin 305 of flexure 300 of FIGS. 3A, 3C). Thus, the regions near the mounting pins 305, while robust, are more readily deflected for installation of the flexure 300 onto the device 101 (FIG. 1), while avoiding localized material stress during installation.

### Extensions and Alternatives

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage, or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps and are not intended to specify or require a particular order of carrying out such steps.

What is claimed is:

1. A storage device carrier assembly comprising:
a flexure comprising:
a laterally-extending end member comprising a flexure region,
a rigid device interface member longitudinally-extending from each end of the end member, and
stiffener attachment features extending from the end member in a direction opposing the device interface members; and
a stiffener removably coupled with the flexure and comprising flexure attachment features configured to mechanically interface with corresponding stiffener attachment features of the flexure.

2. The storage device carrier assembly of claim 1, wherein:
each device interface member of the flexure comprises a device-engagement pin configured for insertion into a corresponding device receptacle of a device to which the flexure is attachable; and
the flexure region of the flexure is configured to bend to allow lateral displacement of the device interface members for insertion of the device-engagement pins into the corresponding device receptacles.

3. The storage device carrier assembly of claim 1, wherein each device interface member of the flexure comprises:
a floor;
a sidewall; and
an end wall coupled with the floor and the sidewall, wherein a portion of the end member functions as the end wall.

4. The storage device carrier assembly of claim 3, wherein the sidewall of at least one device interface member is configured in a triangular form.

5. The storage device carrier assembly of claim 1, wherein:
one or more of the stiffener attachment features of the flexure are configured as hooks; and
one or more of the flexure attachment features of the stiffener are configured as tabs for engagement with a corresponding hook of the flexure.

6. The storage device carrier assembly of claim 1, wherein the stiffener further comprises a top member, a bottom member, and at least one end member all longitudinally-extending for a span greater than a corresponding thickness of the top, bottom, and end members.

7. The storage device carrier assembly of claim 1, wherein:
the flexure further comprises a locking receptacle configured for engagement with a locking feature of the stiffener; and
the stiffener further comprises the locking feature comprising a locking protrusion configured for engagement with the locking receptacle of the flexure.

8. The storage device carrier assembly of claim 1, wherein each of the flexure and the stiffener is composed of a plastic material.

9. A method of attaching a device carrier to a device, the method comprising:
bending a flexure component of the device carrier such that device interface members longitudinally-extending from each lateral end of the flexure component are displaced so that each device interface member can be slipped over a corresponding side of the device; and
slipping each device interface member over the corresponding side of the device while releasing the bending of the flexure component so that a device-engagement protrusion of each device interface member responsively engages with a corresponding device receptacle of the device.

10. The method of claim 9, wherein the bending occurs at a laterally-extending member of the flexure component, from which the device interface members longitudinally extend, that is configured to cover an end of the device.

11. The method of claim 9, further comprising:
aligning attachment features of a stiffener component with corresponding attachment features extending from the flexure component; and
moving the stiffener component relative to the flexure component to mechanically engage the attachment features of the stiffener component with the attachment features of the flexure component.

12. The method of claim 11, wherein:
aligning the attachment features includes aligning tabs of the stiffener component with hooks of the flexure component; and
moving the stiffener component includes mechanically engaging the tabs with the hooks.

13. The method of claim 9, wherein moving the stiffener component further includes mechanically engaging a locking protrusion of the stiffener component with a locking receptacle of the flexure component to reversibly secure coupling of the stiffener component to the flexure component.

14. A storage device assembly comprising:
a storage device; and
a carrier assembly removably coupled to the storage device, the carrier assembly comprising:
a flexure component comprising:
a laterally-extending end member comprising a flexure region,
a rigid device interface member longitudinally-extending from each end of the end member, and
stiffener attachment means extending from the end member in a direction opposing the device interface members; and
a stiffener component removably coupled with the flexure component via flexure attachment means of the stiffener component mechanically engaged with corresponding stiffener attachment means of the flexure component.

15. The storage device assembly of claim 14, wherein the storage device is a hard disk drive (HDD).

16. The storage device assembly of claim 14, wherein the storage device is a solid-state drive (SSD).

17. The storage device assembly of claim 14, wherein:
each device interface member of the flexure component comprises device-engagement means configured for mechanical engagement with a receptacle of the storage device; and
the flexure region of the flexure is configured to bend to allow lateral displacement of the device interface members for insertion of the device-engagement means into the corresponding receptacles.

18. The storage device assembly of claim 14, wherein:
one or more of the stiffener attachment means of the flexure are configured as hooks; and
one or more of the flexure attachment means of the stiffener are configured as tabs for engagement with a corresponding hook of the flexure.

19. The storage device assembly of claim 14, wherein the stiffener further comprises a top member, a bottom member, and at least one end member all longitudinally-extending for a span greater than a corresponding thickness of the top, bottom, and end members.

20. The storage device assembly of claim 14, wherein each of the flexure component and the stiffener component is composed of a plastic material.
